(19) United States
(12) Patent Application Publication
(10) Pub. No.: US 2013/0068809 A1
(43) Pub. Date: Mar. 21, 2013

(54) SUPPORTING FRAME CONNECTABLE TO CAR SEAT

(71) Applicant: Teng WANG, New Taipei City (TW)

(72) Inventor: Teng WANG, New Taipei City (TW)

(21) Appl. No.: 13/238,514

(22) Filed: Sep. 21, 2011

(51) Int. Cl. B60R 7/00

(52) U.S. Cl. 224/275

(57) ABSTRACT

The present invention is to provide a supporting frame connectable to a car seat, which includes an installation rod having a supporting seat installed thereon, two sliding elements mounted around the installation rod in a slidable manner via through holes thereof and each having a first engaging portion on one side thereof, and two assembly elements each having a second engaging portion on one side thereof. The second engaging portion can be brought into engagement with the first engaging portion so that the corresponding assembly element and sliding element are connected together and jointly to form a receiving space therebetween for receiving a headrest post of the car seat. Thus, the installation rod can be fixed to two headrest posts rapidly and conveniently, and a mobile terminal device can be received in and supported by the supporting seat and kept at a predetermined height and position for easy operation.

### FIELD OF THE INVENTION

The present invention relates to a supporting frame, more particularly to a supporting frame connectable to a car seat, including an installation rod, two sliding elements mounted around the installation rod in a slidable manner, and two assembly elements each connected together and jointly with the corresponding sliding element to form receiving space therebetween for receiving a headrest post of the car seat, so that the installation rod can be installed on the headrest posts rapidly and conveniently and, once a supporting seat is installed on the installation portion, a mobile terminal device (e.g., a tablet PC) can be received in and supported by the supporting seat and kept at a predetermined height and position for easy operation.

### BACKGROUND OF THE INVENTION

Recently, with the advancement of microcomputer technology and the development of mobile broadband network connection techniques, the market has been supplied with an increasing number of different portable electronic devices that feature network connectivity and multimedia functions. Some notable examples of such devices are smart phones, personal digital assistants (PDAs), tablet PCs, and e-book readers. These portable electronic devices not only can be carried around more conveniently than personal computers, but also have a wide variety of functions—from the basic ones such as picture taking, music playback, and document preparation, to the more advanced ones such as sending/receiving e-mails and downloading/playing streaming media—with a view to satisfying all kinds of user needs.

Hereinafter, the term “portable electronic device” refers specifically to a portable electronic device having a relatively large size, such as a tablet PC and an e-book reader. To operate such a portable electronic device, it is common practice for the user to hold the device in one hand and operate the touch screen of the device with the other. However, if the portable electronic device is operated in a moving car, the hand holding device is very likely to swing or shake due to the jolting of the car, and the device may end up shaking violently, Should this happen, the user will be unable to have a clear view of the contents displayed on the touch screen, and errors in operation might ensue. Furthermore, as most of the portable electronic devices nowadays use mirror surface touch screens, a shaking operating environment may cause reflections that keep the users from viewing the screen images clearly. Even worse, the shaking of the portable electronic devices tends to cause dizziness or other uncomfortable sensations.

In view of the above and in order to overcome the aforesaid shaking problem of portable electronic devices, an in-car supporting frame for firmly holding a portable electronic device was developed, as shown in FIG. 1. The supporting frame 1 consists essentially of a mount 10 and a support 11. A through hole 100 penetrates the mount 10 and has an inner diameter generally equal to the outer diameter of a headrest post 12. A projecting portion 101 extends from one side of the mount 10 and is pivotally connected with a rear end of the support 11, so as for the support 11 to rotate about the pivotally connecting position. The front side of the support 11 is configured for supporting a portable electronic device (not shown), while hook-like structures provided around the periphery of the support 11 serve to secure the portable electronic device and prevent it from dropping. The structure of the supporting frame 1 is so designed that the portable electronic device, once placed on the support 11, can be operated at a fixed height and position without the user holding the portable electronic device.

Nevertheless, the supporting frame 1 still has room for improvement. Referring to FIG. 1, installation of the supporting frame 1 requires the headrest (not shown) of the car seat be removed in advance, or the mount 10 cannot be mounted around the headrest posts 12. This installation process is both time-consuming and inconvenient and may hamper the user's willingness to use the supporting frame 1. Similarly, removal of the supporting frame 1 requires extra time be taken to detach the headrest again, which is highly undesirable.

Therefore, the issue to be addressed by the present invention is to overcome the various drawbacks of the conventional supporting frames and design a novel supporting frame which adapts to the structure of existing car seats, is easy to install on headrest posts, can secure a portable electronic device at the desired heights and positions, and can prevent the portable electronic device from shaking,

### BRIEF SUMMARY OF THE INVENTION

In consideration of the aforementioned problems of the conventional supporting frames, the inventor of the present invention conducted extensive research and experiment and finally succeeded in developing a supporting frame connectable to a car seat, as disclosed herein. The disclosed supporting frame can be rapidly connected to the headrest posts of a car seat to substantially increase the convenience of use of portable electronic devices in a car ride.

It is an object of the present invention to provide a supporting frame connectable to a car seat, wherein the supporting frame includes an installation rod, two sliding elements, and two assembly elements. The installation rod has an installation portion on which a supporting seat can be installed and which is located proximate to one end of the installation rod. The sliding elements, each penetrated by a through hole corresponding in configuration to the installation rod, are mounted around the installation rod in a slidable manner via their respective through holes. Each sliding element further has a first engaging portion on one side. Meanwhile, each assembly element has a second engaging portion on one side. When the aforesaid sides of the sliding elements are pressed against the headrest posts of a car seat respectively, the second engaging portions can be brought into engagement with the first engaging portions respectively so that each assembly element and the corresponding sliding element are connected together and jointly to form a receiving space therebetween for receiving the corresponding headrest post. Thus, the installation rod is fixed to the headrest posts. According to the above, the supporting frame can be installed on the headrest posts rapidly and conveniently, and once the supporting seat is installed on the installation portion, a mobile terminal device (e.g., a tablet PC) can be received in and supported by the supporting seat and kept at a predetermined height and position for easy operation, without the user holding the mobile terminal device. As such, the mobile terminal device is protected from violent shaking which may otherwise result from jerky movement of the user's hand. The mobile terminal device is also well prevented from accidental dropping during a bumpy ride. Consequently, the convenience of use of the mobile terminal device in the car is greatly enhanced.

It is another object of the present invention to provide the foregoing supporting frame, wherein the supporting frame further includes two fasteners which are connected to the assembly elements respectively and threadedly. Each fastener has one end passing through the corresponding assembly element and extending into the corresponding receiving space so as to press against the corresponding headrest post. Thus, the headrest posts are securely and tightly clamped between the fasteners and the sliding elements.

Still another object of the present invention is to provide the foregoing supporting frame, wherein the installation rod is laterally and axially provided with a slide rail, and each sliding element has an inner side formed with a rail portion corresponding in position to the slide rail. The rail portions of the sliding elements are slidably disposed on the slide rail to limit the sliding elements, prevent the sliding elements from rotating about the installation rod, and thereby facilitate installation of the supporting frame.

Yet another object of the present invention is to provide the foregoing supporting frame, wherein the installation portion is a universal joint. The universal joint allows the supporting seat installed thereon to rotate freely to the desired angles.

### BRIEF DESCRIPTION OF THE SEVERAL VIEWS OF THE DRAWINGS

The structure as well as a preferred mode of use, further objects, and advantages of the present invention will be best understood by referring to the following detailed description of some illustrative embodiments in conjunction with the accompanying drawings, in which:

FIG. 1 is a perspective view of a conventional supporting frame;

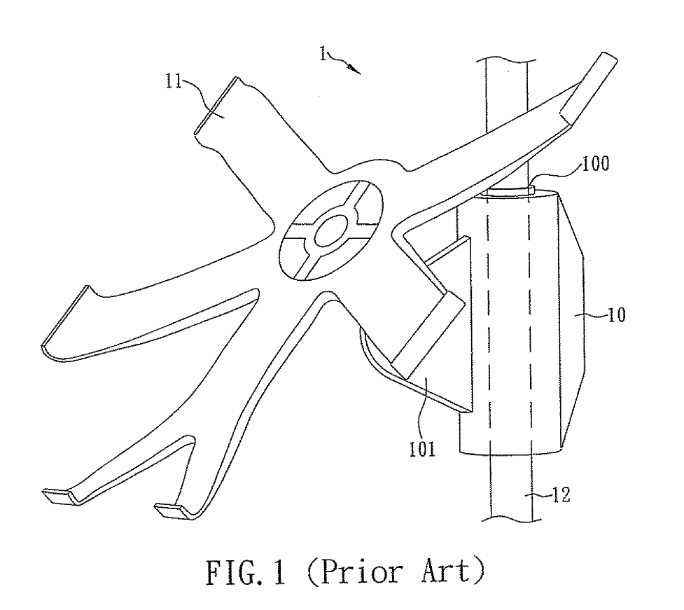

FIG. 2 is an exploded perspective view of the first preferred embodiment of the present invention;

FIG. 3 is a partial sectional view of the first preferred embodiment of the present invention;

FIG. 4 is a partial perspective view of the first preferred embodiment of the present invention;

FIG. 5 is another partial sectional view of the first preferred embodiment of the present invention;

FIG. 6 schematically shows the first preferred embodiment of the present invention in use; and

FIG. 7 is a partial perspective view of the second preferred embodiment of the present invention.

### DETAILED DESCRIPTION OF THE INVENTION

The inventor of the present invention has long been engaged in the research and development of portable electronic devices (e.g., tablet PCs) and their peripheries. In the process, the inventor has found that a portable electronic device tends to shake when operated in a running car. While an in-car supporting frame has been developed to solve the shaking problem, the supporting frame requires an arduous installation process and therefore leaves much to be desired in terms of practical use. The industry has attempted to make further improvement to the aforesaid supporting frame, but an ideal solution has yet to be found. In consideration of the above, the inventor of the present invention came up with a novel supporting frame to be installed via mutually engageable components. This supporting frame can be rapidly installed on the headrest posts of a car seat so as to support a portable electronic device and thereby facilitate in-car use thereof.

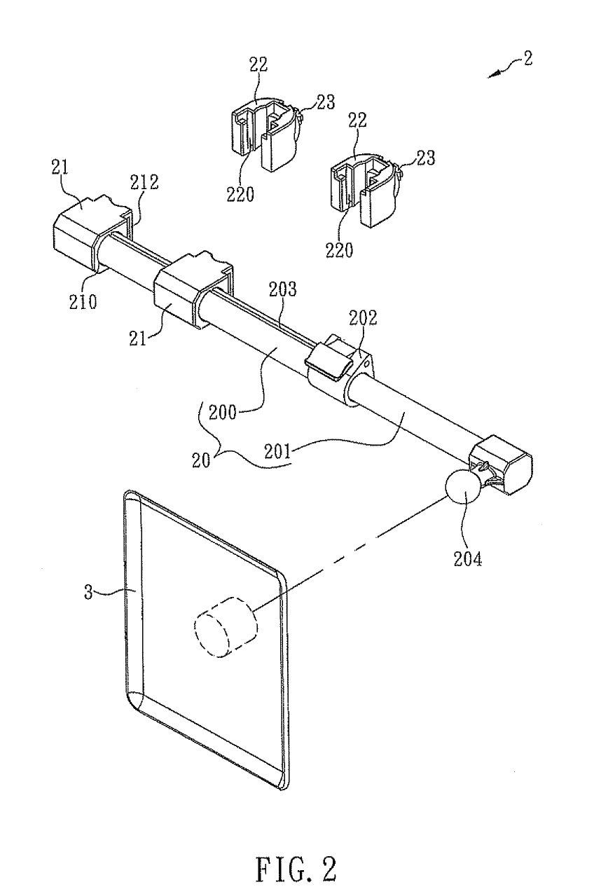

The present invention provides a supporting frame connectable to a car seat. Referring to FIG. 2, a supporting frame 2 according to the first preferred embodiment of the present invention includes an installation rod 20, two sliding elements 21, and two assembly elements 22. The installation rod 20 is composed of a main rod 200 and an extension rod 201. The main rod 200 is mounted around the extension rod 201 in such a way that the extension rod 201 can be translated in the main rod 200 to adjust the length of the installation rod 20. In addition, the end of the main rod 200 that is adjacent to the extension rod 201 is provided with a clamping element 202. The clamping element 202 is configured for clamping the main rod 200 and the extension rod 201 tightly and thus fixing them at the desired length. It should be pointed out that, while the installation rod 20 in the first preferred embodiment is composed of the main rod 200 and the extension rod 201, the present invention imposes no limitations in this regard. As appropriate, a manufacturer of the supporting frame 2 may use a single main rod as the installation rod or, alternatively, increase the number of the extension rod and connect the plural extension rods telescopingly. All variations easily conceivable by a person skilled in the art should fall within the scope of the present invention.

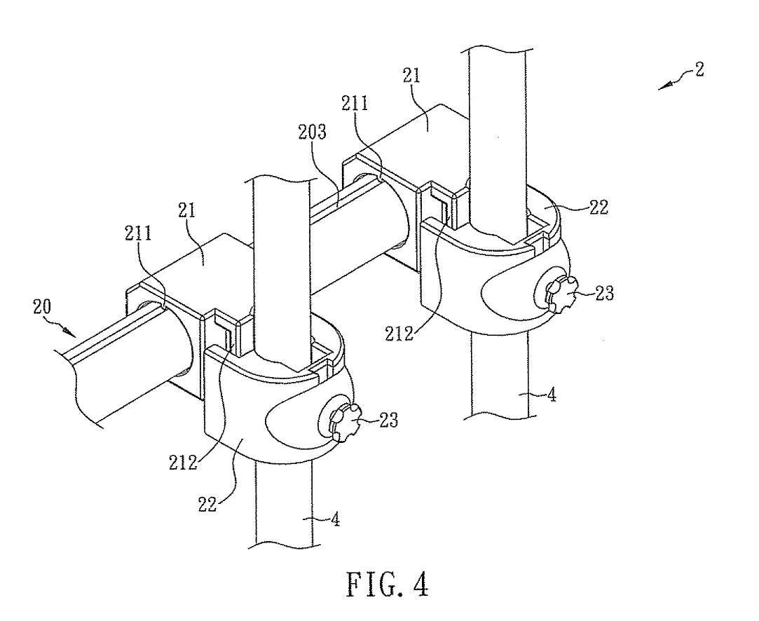

Referring again to FIG. 2, the installation rod 20 is axially provided with a slide rail 203 on one outer side. The installation rod 20 is also provided with an installation portion 204, which is located proximate to one end of the extension rod 201. The other end of the extension rod 201 is movable in the main rod 200. The installation portion 204, which is a universal joint in this preferred embodiment, is configured for connecting a supporting seat 3 to the installation rod 20 while allowing the supporting seat 3 to rotate freely on the installation portion 204. On the other hand, each sliding element 21 is penetrated by a through hole 210 corresponding in configuration to the main rod 200. The two sliding elements 21 are slidably mounted around the main rod 200 via their respective through holes 210. As shown in FIG. 4, each sliding element 21 has an inner side formed with a rail portion 211 corresponding in position to the slide rail 203. The rail portions 211 of the sliding elements 21 are slidably disposed on the slide rail 203 in order to limit the sliding elements 21 and prevent the sliding elements 21 from rotating about the installation rod 20. This technical feature ensures that the sliding elements 21 are aligned with each other without relative rotation therebetween, so as to facilitate subsequent installation.

As shown in FIGS. 2 and 4, each sliding element 21 has a first engaging portion 212 on one side, and each assembly element 22 has a second engaging portion 220 on one side. The first engaging portions 212 correspond in configuration to the second engaging portions 220. In the first preferred embodiment, each sliding element 21 has one side protrudingly provided with two projections that are located at opposite positions and serve as the first engaging portion 212. Also, each assembly element 22 has a sunken side and is concavely provided with two recesses corresponding in position to the first engaging portion 212 of each sliding element 21 and serving as the second engaging portion 220. However, the configurations of the first engaging portions 212 and the second engaging portions 220 are not limited to the foregoing and may vary without departing from the concept of the present invention. All equivalent changes readily conceivable by a person of skill in the art should fall within the scope of the present invention.

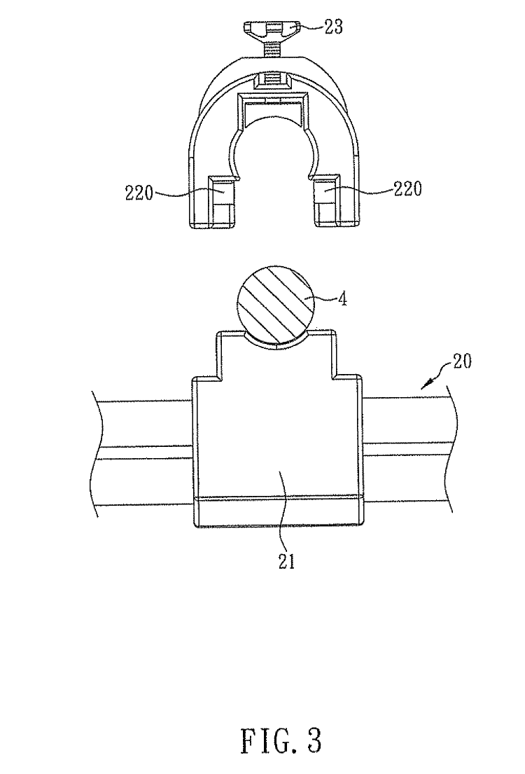

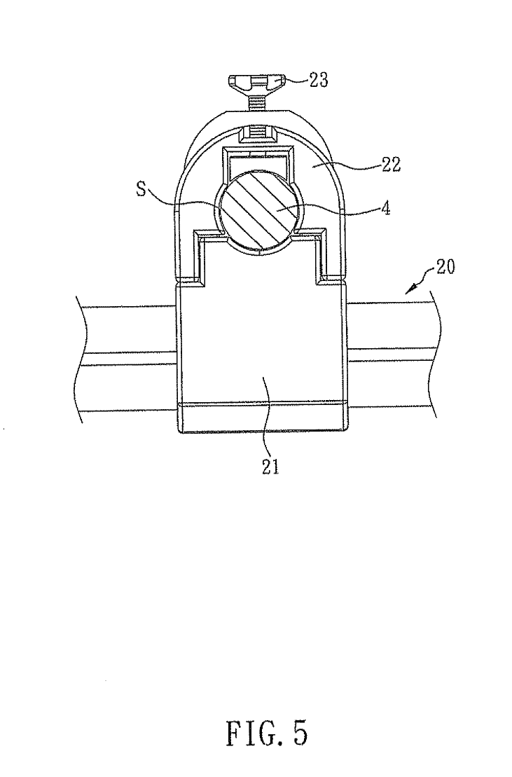

Referring to FIGS. 3 through 5, once the aforesaid sides of the sliding elements 21 are respectively pressed against the headrest posts 4 of a car seat, the second engaging portions 220 can be brought into engagement with the first engaging portions 212 respectively (see FIG. 4) so that each assembly element 22 is connected with the corresponding sliding element 21 (see FIG. 5). At the same time, each assembly element 22 and the sliding element 21 connected therewith jointly form a receiving space S therebetween for receiving the corresponding headrest post 4. As a result, the installation rod 20 is fixed to the headrest posts 4. In addition, referring to FIGS. 4 and 5, the supporting frame 2 includes two fasteners 23 respectively and threadedly connected to the assembly elements 22. Each fastener 23 has one end penetrating the corresponding assembly element 22 and extending into the corresponding receiving space S so as to press against the corresponding headrest post 4, thereby clamping the headrest post 4 firmly and tightly between the fastener 23 and corresponding sliding element 21. By means of the fasteners 23, a user can secure the supporting frame 2 of the present invention firmly to the headrest posts 4 to prevent the supporting frame 2 from shaking or getting loose, hence increasing the structural stability of the assembly significantly.

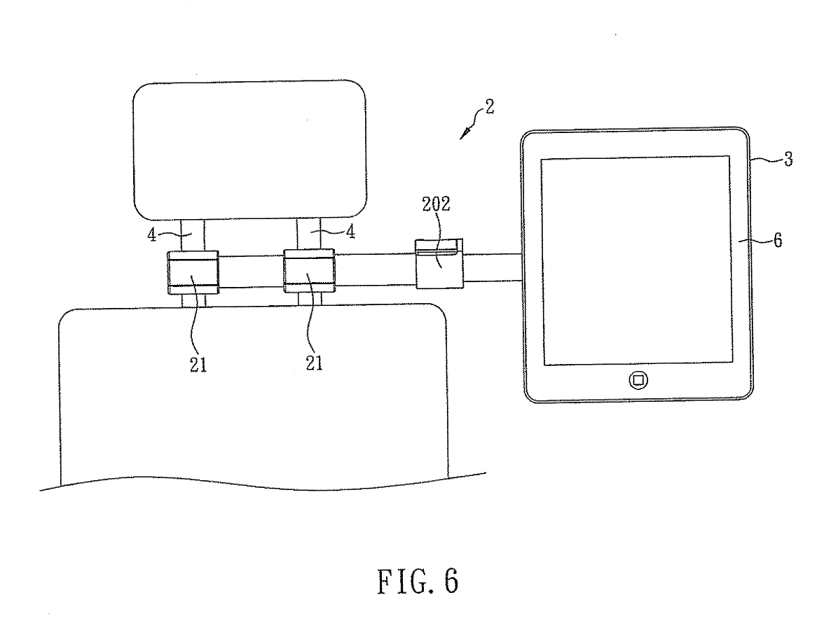

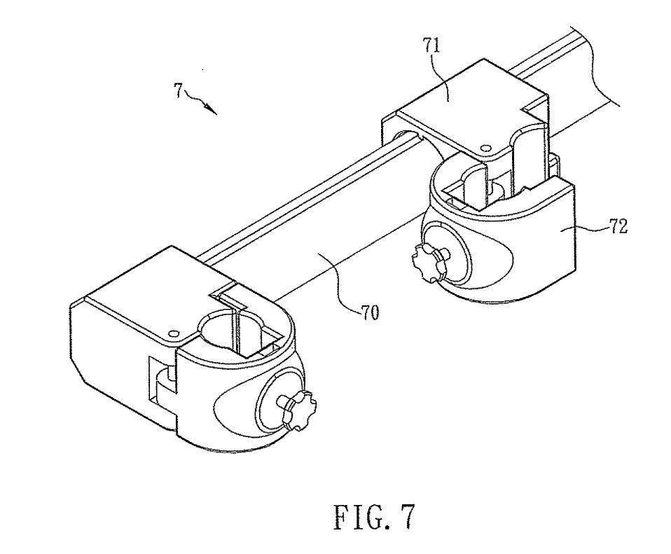

Referring to FIG. 6, as the structural design of the present invention matches the headrest posts 4 of an existing car seat, the supporting frame 2 can be rapidly and easily installed on the headrest posts 4 without the complicated installation steps required by the conventional supporting frames. Once the supporting seat 3 is installed on the installation portion 204 (see FIG. 2), a mobile terminal device 6 received in and supported by the supporting seat 3 can be fixed at a predetermined height and position for easy operation without the user holding the mobile terminal device 6. With the supporting frame 2 being firmly positioned on the headrest posts 4 of the car seat, the mobile terminal device 6 is protected not only from violent shaking which may otherwise result from a shaking hand holding the device, but also from accidental dropping during a bumpy ride. Moreover, as the installation height of the supporting frame 2 and the angle of the supporting seat 3 are freely adjustable, a user may change the height and angle of the mobile terminal device 6 according to his or her sitting height for enhanced convenience of use. It is also worth mentioning that the structural simplicity and spatial economy of the present invention allow the supporting frame 2 to be easily stored. In the second preferred embodiment of the present invention as shown in FIG. 7, the supporting frame 7 includes sliding elements 71 which are slidable along the installation rod 70 and which are respectively and pivotally connected to the assembly elements 72 such that the assembly elements 72 are rotatable about the pivotally connecting positions respectively. Thus, the convenience of use of the supporting frame 7 is further increased, and the assembly elements 72 are prevented from loss.

While the invention herein disclosed has been described by means of specific embodiments, numerous modifications and variations could be made thereto by those skilled in the art without departing from the scope of the invention set forth in the claims.

What is claimed is:

1. A supporting frame connectable to a car seat, comprising:
an installation rod provided with an installation portion, the installation portion being disposed proximate to an end of the installation rod and configured for connecting with a supporting seat;
two sliding elements, each penetratedly provided with a through hole corresponding in configuration to the installation rod, the sliding elements being slidably mounted around the installation rod via the through holes, each said sliding element having a side provided with a first engaging portion; and
two assembly elements, each having a side provided with a second engaging portion, wherein when the sides of the sliding elements are respectively pressed against two headrest posts of the car seat, the second engaging portions can be engaged with the first engaging portions respectively so as to connect each said assembly element to a corresponding said sliding element and form therebetween a receiving space for receiving a corresponding said headrest post, thereby securing the installation rod to the headrest posts.

2. The supporting frame of claim 1, wherein the installation rod has an outer side axially provided with a slide rail, and each said sliding element has an inner side formed with a rail portion corresponding in position to and slidably disposed on the slide rail.

3. The supporting frame of claim 2, further comprising two fasteners respectively and threadedly connected to the assembly elements, wherein each said fastener has an end passing through a corresponding said assembly element and extending into a corresponding said receiving space so as to press against a corresponding said headrest post.

4. The supporting frame of claim 3, wherein the sliding elements are respectively and pivotally connected to the assembly elements.

5. The supporting frame of claim 4, wherein the installation rod is composed of a main rod and an extension rod, and the through hole of each said sliding element corresponds in configuration to the main rod, the sliding elements being slidably mounted around the main rod via the through holes, the installation portion being located proximate to an end of the extension rod, the main rod being mounted around the extension rod in such a way that an opposite end of the extension rod is movable in the main rod.

6. The supporting frame of claim 5, wherein the main rod has an end adjacent to the extension rod and provided with a clamping element for tightly clamping the main rod and the extension rod.

7. The supporting frame of claim 6, wherein the installation portion is a universal joint.
